(19) United States
(12) Patent Application Publication
(10) Pub. No.: US 2009/0204659 A1
(43) Pub. Date: Aug. 13, 2009

(54) N-BIT ADDER AND CORRESPONDING ADDITION METHOD

(75) Inventor: Daniel Torno, Orleans (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: S.A.R..L. DANIEL TRONO, ORLENS (FR)

(21) Appl. No.: 12/297,796

(22) PCT Filed: Apr. 19, 2007
(86) PCT No.: PCT/FR07/00655

§ 371 Date: Apr. 21, 2009

(30) Foreign Application Priority Data
Apr. 21, 2006 (FR) 0603549

(51) Int. Cl. G06F 7/506; G06F 7/508

(52) U.S. Cl. 708/714

(57) ABSTRACT

An adder is provided for adding input signals including first and second binary input numbers, with N bits each. The adder includes a determination circuit capable of determining the bits of the sum of the input signals. The determination circuit includes an estimating circuit including estimating blocks connected in series, each estimating block being capable of estimating each bit of the sum, and a correction circuit capable of generating a correction signal so as to correct each estimated bit of the sum after each estimate. Each correction signal of an estimated bit rank i of the sum is generated using the last rank i−1 estimated and corrected bit of the sum, the correction signal of said last rank i−1 bit, and the last estimated and corrected rank i−2 bit of the sum.

### CROSS-REFERENCE TO RELATED APPLICATIONS

This Application is a Section 371 National Stage Application of International Application No. PCT/FR2007/000655, filed Apr. 19, 2007, and published as WO 2007/122319 on Nov. 1, 2007, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The disclosure relates to digital adders, in particular to the adders formed of half-adders mounted in cascade.

### BACKGROUND OF THE DISCLOSURE

Conventionally, in order to carry out an addition between two input bits, and an input carry value, use is made of two half-adders mounted in cascade. The first adder performs the sum of the two bits and delivers as output the result of the sum and a first intermediate carry value. The second half-adder receives as input the input carry value and the result of the sum obtained previously, and delivers as output on the one hand the sum of the input carry value and the two input bits and on the other hand the final carry value.

In order to perform the sum of two binary numbers of N bits each, it is possible to use several times this pair of half-adders connected in cascade, as described for example in the work “Logic circuits for the digital processing of information” (“Circuits logiques de traitement numérique de l'information” in French) by J. Chinal, published by Cepadues Editions, 1979, ISBN 2.85428.040.7, pages 105 to 112.

In this case, each bit of rank k of the sum of the two input numbers is estimated and corrected k times by the successive carry values generated at each half-adder stage.

However, this type of adder only allows corrections with positive carry values.

Furthermore, the initial estimate of the bits of the sum and of the carry values in standard adders is incompatible with the constraints of reversible logic, that is to say the possibility of recovering the input signal from an output signal.

Moreover, this type of standard adder requires the propagation of each carry value generated at each processing stage, which may be pointless for some applications, for example in the case of using half-adders to carry out divisions.

### SUMMARY

According to a first aspect of the invention, there is proposed a method for adding input signals comprising a first and a second binary input numbers, of N bits each.

According to a general feature of this first aspect of the invention, the bits of the sum of the input signals are determined by making a number of estimates of each bit of said sum and by correcting said estimates with the aid of a correction signal after each estimate, each correction signal of an estimated bit of rank i of the sum being produced using the last estimated and corrected bit of rank i−1 of the sum, the correction signal of said last bit of rank i−1 and the last estimated and corrected bit of rank i−2 of the sum.

In other words, several estimates (j) of each bit of the sum of the input signals are made successively.

After each estimate, a correction is applied to the estimated bit of the sum, then a new estimate is made based on the previous corrected estimate of this same bit.

In other words, said estimates (U^{j}) are corrected with the aid of a correction signal (R^{j}) after each estimate, each correction bit of rank (n+1) (Rₙ^{j}) being produced using the last estimate of the bit of rank (n) (Uₙ₋₁^{j-1}), the last correction bit of rank (n) (Rₙ₋₁^{j-1}), and the last estimate of the bit of rank (n−1) (Uₙ₋₂^{j-1}).

This method has the advantage of being able to carry out both negative and positive corrections at each estimate of the bits of the sum. Processes which use additions/subtractions in an iterative manner are improved as a result.

The input signals may also comprise an input carry value.

Preferably, the method further comprises an initialisation step in which the value of the estimated bits of said sum and the value of the correction signals are initialised, and j successive processing steps, j being an integer less than or equal to N, where, during the k^{th} step, k ranging from 1 to j, the bits of the sum for which the rank i is between k and N are estimated, and the i^{th} correction signal is produced for each bit of rank i, each estimated bit of the sum of rank i being estimated from the estimated bit of the sum of rank i and from the i^{th} correction signal, respectively estimated and produced during the previous step, the i^{th} correction signal being produced from the estimated bits of the sum of rank i−1 and of rank i−2 and from the (i−1)^{th} correction signal, respectively estimated and produced during the previous step.

It is also possible to produce an output carry value from all of the N^{th} correction signals.

According to one embodiment, the initialisation of each estimated bit of said sum is a function of the bits of equal rank of the first and second input numbers, and the initialisation of the value of the correction signal of each estimated bit is a function of the bits of previous rank of the first and second input numbers.

In this case:

$$\{ \begin{matrix}{U}_{n}^{0} = {a}_{n} ⊕ {b}_{n} \\ {R}_{n}^{0} = {a}_{n - 1} \cdot {b}_{n - 1}\end{matrix}$$

where:

Uₙ⁰ is the initial value of the estimated bit of the sum of the input signals, of rank n+1, n ranging from 0 to N−1,

Rₙ⁰ is the initial value of the correction signal of the estimated bit of the sum of the input signals, of rank n+1, n ranging from 0 to N−1,

aₙ and bₙ being the bits of rank n+1, respectively of the first and second input numbers.

According to another embodiment, the initialisation of each estimated bit of said sum is a function of the complement of the bit of equal rank of the first input number, and the initialisation of the value of the correction signals of each estimated bit is a function of the bit of previous rank of the first input number and of the bit of equal rank of the second input number.

In this other case:

$$\{ \begin{matrix}{U}_{n}^{0} = \overline{{a}_{n}} \\ {R}_{n}^{0} = \overline{{a}_{n - 1} ⊕ {b}_{n}}\end{matrix}$$

where:

Uₙ⁰ is the initial value of the estimated bit of the sum of the input signals, of rank n+1, n ranging from 0 to N−1,

Rₙ⁰ is the initial value of the correction signal of the estimated bit of the sum of the input signals, of rank n+1, n ranging from 0 to N−1,

aₙ and bₙ being the bits of rank n+1, respectively of the first and second input numbers.

The initialisation of the signals according to this embodiment has the advantage of being compatible with the logic of reversibility.

In one embodiment, j is equal to N, and the bit of rank k of said sum corresponds to the estimated bit of rank k of the sum, estimated during the k^{th} processing step.

In another embodiment, the method further comprises, after the j processing steps, a step of generating N−1 propagation signals, the q^{th} propagation signal being a function of the estimated bit of said sum of rank q, of its correction signal, and of the estimated bit of rank q−1 of said sum, and in which each bit of said sum is calculated from the q^{th} propagation signals, such that q is below the rank of the bit in question.

According to another aspect of the invention, there is proposed an adder for adding input signals comprising a first and a second binary input numbers, of N bits each.

According to one general feature of this other aspect of the invention, said adder comprises determination means capable of determining the bits of the sum of the input signals, comprising:
estimating means comprising estimating blocks connected in series, each estimating block being capable of estimating each bit of said sum, and
correction means capable of producing a correction signal so as to correct, after each estimate, each estimated bit of said sum, each correction signal for correcting an estimated bit of rank i of the sum being produced using the last estimated and corrected bit of rank i−1 of the sum, the correction signal of said last bit of rank i−1, and the last estimated and corrected bit of rank i−2 of the sum.

The input signals may also comprise an input carry value.

Preferably, the adder further comprises initialisation means coupled upstream of the determination means and capable of initialising the value of the estimated bits of said sum and the value of the correction signals, the determination means comprising j processing means coupled in series, j being an integer less than or equal to N, where the k^{th} processing means, k ranging from 1 to j, comprise:
said estimating blocks for estimating the bits of the sum for which the rank i is between k and N, being estimated from the estimated bit of the sum of rank i and from the i^{th} correction signal, respectively estimated and produced by the processing means connected upstream, and
the correction means capable of producing, for each bit of rank i, the i^{th} correction signal from the estimated bits of the sum of rank i−1 and of rank i−2 and from the (i−1)^{th} correction signal, respectively estimated and produced by the processing means connected upstream.

Preferably, for the k^{th} processing means, each estimating block for estimating a bit of the sum of rank i comprises a logic gate of the “EXCLUSIVE OR” type capable of receiving as input the estimated bit of the sum of rank i and the i^{th} correction signal, respectively estimated and produced by the (k−1)^{th} processing means, and in which the correction means for correcting an estimated bit of the sum of rank i+1 comprise another logic gate of the “EXCLUSIVE OR” type capable of receiving as input the estimated and corrected bit of the sum of rank i−1 and the bit of rank (i−2) of the sum estimated and produced by the (k−1)^{th} processing means, and a logic gate of the “AND” type coupled to the output of the other logic gate of the “EXCLUSIVE OR” type and capable of receiving as input the output signal of said other logic gate and the (i−1)^{th} correction signal estimated and produced by the (k−1)^{th} processing means.

The processing means may further comprise production means capable of producing an output carry value from all of the N^{th} correction signals.

Preferably, the initialisation means are capable of initialising the value of each bit to be estimated of said sum as a function of the bits of equal rank of the first and second input numbers, and are capable of initialising the value of the correction signal of each bit to be estimated as a function of the bits of previous rank of the first and second input numbers.

According to one embodiment, the initialisation means comprise N elementary initialisation means, each being associated with a given rank, comprising a logic gate of the “EXCLUSIVE OR” type, capable of receiving the bits of the rank in question of the first and second input numbers, and capable of delivering, for the rank in question, the initial value of the bit to be estimated of the sum, and a logic gate of the “AND” type, capable of receiving the bits of the rank in question of the first and second input numbers, and capable of delivering the initial value of the correction signal of the estimated bit of the sum, of the rank following the rank in question.

According to another embodiment, the initialisation means comprise N elementary initialisation means, each being associated with a given rank, comprising an inverter logic gate, capable of receiving the bits of the rank in question of the first input number, and capable of delivering, for the rank in question, the initial value of the bit to be estimated of the sum, and a logic gate of the “EXCLUSIVE OR” type with an inverter output, capable of receiving the bit of the rank in question of the first input number and the bit of the rank following the rank in question of the second input number, and capable of delivering the initial value of the correction signal of the estimated bit of the sum, of the rank following the rank in question.

According to a first variant, j is equal to N, and the bit of the sum of rank k corresponds to the bit of the sum of rank k estimated by the k^{th} processing means.

According to a second variant, the adder further comprises generation means coupled to the j^{th} processing means, capable of generating N−1 propagation signals, the q^{th} propagation signal being a function of the estimated bit of said sum of rank q, of its correction signal, and of the estimated bit of rank q−1 of said sum, and calculation means capable of calculating each bit of said sum from the q^{th} propagation signals, such that q is below the rank of the bit in question.

In this case, the generation means may generate an N^{th} propagation signal as a function of the estimated bit of rank N, of its correction signal and of the estimated bit of rank N−1. The calculation means may further comprise a calculation block capable of calculating a group generation term from all of the propagation signals generated and from all of the correction signals, and a group propagation term from all of the propagation signals.

According to one embodiment, if N is even, the calculation block may then comprise:
N logic gates of the “AND” type, the q^{th} gate, q ranging from 1 to N, being capable of receiving k propagation signals, k ranging from 1 to q, and the k^{th} correction signal,
a network of logic gates of the “EXCLUSIVE OR” type, capable of adding all of the terms delivered at the output of the logic gates of the “AND” type, so as to produce said group generation term,
an additional logic gate of the “AND” type, capable of multiplying all of the propagation signals so as to produce said group propagation term.

According to another aspect of the invention, there is proposed a system comprising a network of adders according to the first aspect of the invention.

For example, the system may comprise a network of adders incorporating adders according to the first or second variant.

Furthermore, if N is a multiple of 4, the system may comprise a network of adders incorporating N/4 adders according to the third variant and the various embodiments derived therefrom (and such that the input signals comprise an input carry value), coupled in parallel, each adder being capable of adding N/4 successive bits of the first and second binary input number. Said system may further comprise at least one group propagation module (MPGi) capable of receiving the group generation term and the group propagation term of each adder, and capable of producing from the group generation term and the group propagation term of a given adder a carry value for the adder which adds the following N/4 bits.

A simple and iterative calculation structure may also be obtained by integrating in the system a second network of adders at the bit level, in which the correction signal is propagated in cascade from the module of rank (n) to the module of rank (n+1) on the “ripple carry adder” model known to the person skilled in the art.

### BRIEF DESCRIPTION OF THE DRAWINGS

Other advantages and features will become apparent on reading the detailed description of one mode of implementing the method and of several non-limiting embodiments of the invention and from looking at the appended drawings, in which:

FIG. 1 shows one mode of implementing the method according to an aspect of the invention,

FIG. 2 shows a block diagram of one embodiment of an adder according to an aspect of the invention,

FIG. 3 shows in greater detail an embodiment of an adder according to an aspect of the invention,

FIG. 4 shows a variant embodiment of an adder according to an aspect of the invention,

FIG. 5 shows another embodiment of an adder according to an aspect of the invention,

FIG. 6 shows another embodiment of an adder according to an aspect of the invention,

FIGS. 7 and 8 show embodiments of an adder system according to an aspect of the invention,

FIG. 9 shows another embodiment of an adder according to an aspect of the invention.

### DETAILED DESCRIPTION OF ILLUSTRATIVE EMBODIMENTS

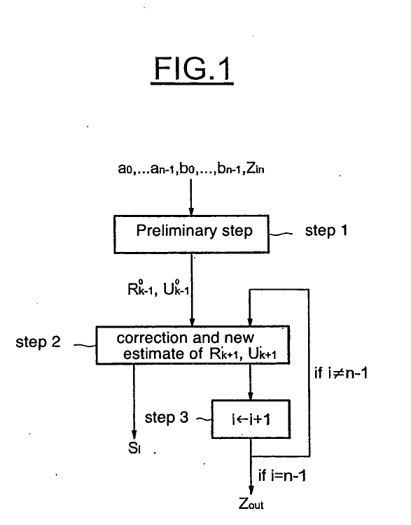

Reference is made to FIG. 1, which shows a flowchart with the different steps of one mode of implementing a method according to an aspect of the invention.

During a first step (preliminary step, step 1), different signals Rₖ₋₁⁰, Uₖ₋₁⁰ are initialised, used to perform the sum of two binary numbers, respectively A (a₀, . . . , aₙ₋₁) and B (b₀, . . . , bₙ₋₁), and a possible carry value Zᵢₙ. The definition of the terms R and U will be seen in greater detail below.

During a step 2, the previously calculated signals R and U are corrected, then a new estimate is made (step 2; correction and new estimate of Rₖ₊₁ⁱ, Uₖ₊₁ⁱ).

At the end of step 2, the bit of the sum of the input signals (A, B, Zᵢₙ) of rank i is generated, Si.

Then, during a step 3, the value of i is incremented by one block (step 3, i←i+1), then steps 2 and 3 are repeated so as to generate all the bits of the sum S.

Once the last bit of the sum S has been generated, the output carry value Zₒᵤₜ is calculated.

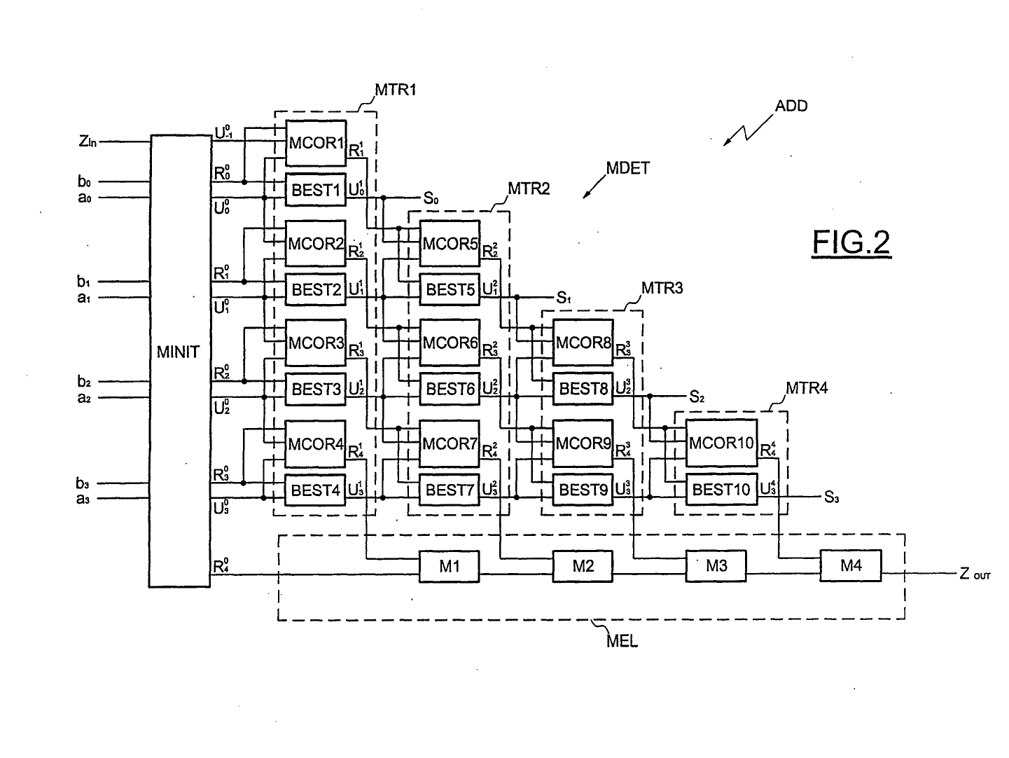

Reference is now made to FIG. 2, which schematically describes one embodiment of an adder which makes it possible to implement an aspect of the invention, for example the flowchart of FIG. 1. Reference ADD denotes an adder according to one embodiment of the invention. It comprises determination means MDET capable of receiving as input an input carry value Zᵢₙ and two binary input numbers A and B, each having four bits in this example, respectively a₀, . . . , a₃ and b₀, . . . , b₃.

All of the bits and also the input carry value Zᵢₙ are delivered to initialisation means MINIT. The initialisation means MINIT initialise the signals R and U according to an algorithm described in greater detail below.

Consequently, the initialisation means MINIT deliver as output respectively the signals U₀⁰, . . . , U₃⁰ and R₀⁰, . . . , R₃⁰.

The initialisation means MINIT also deliver the signals U₋₁⁰, the initialisation of which will be described in greater detail below, and R₄⁰ which corresponds to a first estimate of the output value of the adder ADD.

The initialisation means MINIT are connected to a first processing stage MTR1 capable of delivering a first estimate of the bits of the sum S, which correspond respectively to the signals U₀¹, . . . , U₃¹, and correction signals for correcting these estimated bits of the sum, which are respectively the signals R₁¹, . . . , R₃¹.

The estimated bits of the sum U₀¹ . . . , U₃¹ are respectively estimated by estimating blocks BEST1, . . . , BEST4.

The first processing stage MTR1 also delivers a correction signal R₄¹ for the output carry value, R₄⁰.

The correction signals R₁¹, . . . , R₄¹ are respectively produced using correction means, respectively MCOR1, . . . , MCOR4.

In this embodiment, the first processing stage MTR1 delivers the first bit S0 of the sum S, which corresponds to the first estimate of this bit, i.e. U₀¹.

Similarly, the determination means MDET comprise a second processing stage MTR2. The latter incorporates the correction means MCOR5, MCOR6 and MCOR7 and the estimating blocks BEST5, BEST6 and BEST7.

The latter deliver respectively the correction signals R₂², . . . , R₄² and the estimated bits of the sum U₁², . . . , U₃².

The estimated bit U₁² corresponds to the second bit of the sum S1.

Third processing means MTR3 are connected to the output of the means MTR2. These means MTR3 comprise correction blocks MCOR8 and MCOR9 and estimating means BEST8 and BEST9.

In the same way as for the previous stages, the latter deliver the correction signals R₃³ and R₄³ and the estimated bits U₂³, which corresponds to the third bit of the sum S2, and U₃³.

The processing means MTR4 are connected to the output of the processing means MTR3 and comprise the correction means MCOR10 and the estimating block BEST10, delivering respectively the correction signal R₄⁴ and the estimated bit U₃⁴, the latter corresponding to the last bit of the sum S3.

All of the estimating blocks BESTi, i ranging from 1 to 10, form the estimating means within the determination means MDET.

Each of the correction means MCORi, i ranging from 1 to 10, delivering a correction signal Rₙ^{j}, receives as input the signals Uₙ₋₁^{j-1}, Uₙ₋₂^{j-1} and the correction signal Rₙ₋₁^{j-1}, n and j ranging in this example from 0 to 3.

In the particular case of MCOR1, the signal U₋₁⁰ (defined below) is delivered as input, so as to be able to produce the correction signal R₁¹.

The determination means also comprise production means MEL, comprising four means M1, M2, M3 and M4 connected in series.

The means Mi, i ranging in this case from 1 to 4, receive as input the output signal from the means Mi−1 and the correction signal R₄¹.

The means M1 receive as input the first estimate of the output carry value, i.e. R₄⁰, delivered by the initialisation means MINIT.

The means M4 deliver as output the final value of the output carry value Zₒᵤₜ.

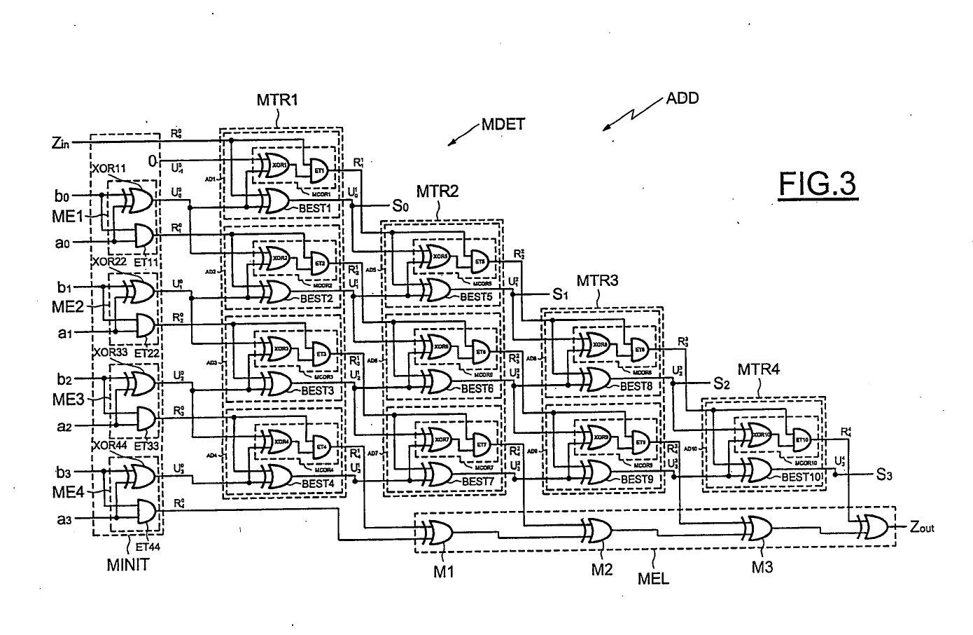

Reference is now made to FIG. 3, which describes in greater detail the initialisation means MINIT, the correction means MCORi, the estimating blocks BESTi, i ranging from 1 to 0, and the means M1, M2, M3 and M4 of the production means MEL.

In this embodiment, each estimating block BESTi, incorporated in a stage n+1, n ranging from 0 to 3, and i ranging from 1 to 10, comprises a logic gate of the “EXCLUSIVE OR” type.

The correction means MCORi of a stage n+1 comprise a logic gate of the “EXCLUSIVE OR” type, referenced XORi, capable of receiving the estimated bit of the sum Uₙ₋₁ⁱ⁻¹ and the estimated bit of the sum Uₙ₋₂ⁱ⁻¹. Furthermore, the means MOCORi comprise a logic gate of the “AND” type, referenced ETi, and capable of receiving the output signal delivered by the logic gate XORi and the correction signal Rₙ₋₁ⁱ⁻¹.

Consequently, the estimated bits Uₙⁱ and the correction signals Rₙⁱ are determined from the following equations known as “propagation equations”:

$$\{ \begin{matrix}{U}_{n}^{i} = {U}_{n}^{i - 1} ⊕ {R}_{n}^{i - 1} \\ {R}_{n}^{i} = ( {U}_{n - 1}^{i - 1} ⊕ {U}_{n - 2}^{i - 1} ) \cdot {R}_{n - 1}^{i - 1}\end{matrix}$$

By developing the above propagation equations, the following is obtained:

$$\{ \begin{matrix}{S}_{n} = {U}_{n}^{i} = {U}_{n}^{0} ⊕ {R}_{n}^{0} ⊕ {R}_{n}^{i} ⊕ … ⊕ {R}_{n}^{i - 2} ⊕ {R}_{n}^{i - j} \\ {R}_{n}^{i} = ( {U}_{n - 1}^{0} ⊕ {R}_{n - 1}^{0} ⊕ {U}_{n - 2}^{0} ⊕ 1 ) \cdot ( {U}_{n - 2}^{0} ⊕ {R}_{n - 2}^{0} ⊕ {U}_{n - 3}^{0} ⊕ 1 ) \cdot … ( {U}_{n - i}^{0} ⊕ {R}_{n - i}^{0} ⊕ {U}_{n - i - 1}^{0} ⊕ 1 ) \cdot {R}_{n - 1}^{0}\end{matrix}$$

where Sₙ is the bit of index n of the sum of the input numbers A, B and of the input carry value Zᵢₙ.

The means M1, M2, M3, M4 are each formed of a logic gate of the “EXCLUSIVE OR” type.

The output carry value Zₒᵤₜ can for its part be expressed by the following expression:

Zₒᵤₜ=R₄⁰⊕R₄¹⊕R₄²⊕R₄³⊕R₄⁴

FIG. 3 illustrates a first embodiment of the initialisation means MINIT.

In this embodiment, the correction signal R₀⁰ corresponds to the input carry value Zᵢₙ.

The variable U₋₁⁰ is in this case assigned the value “0”.

The initialisation means MINIT comprise four elementary initialisation means ME1, . . . , ME4.

Each means MEi, i ranging here from 1 to 4, comprises a logic gate of the “EXCLUSIVE OR” type and a logic gate of the “AND” type, respectively referenced XORii and ETii. Each of these gates receives respectively the bits of the input numbers aᵢ₋₁ and bᵢ₋₁.

Each logic gate ETii delivers as output the correction signal Rᵢ⁰.

Each logic gate XORii delivers as output an initial value of the estimated bit Uᵢ₋₁⁰.

Consequently, the equations implemented by the initialisation means in this example are as follows:

$$\{ \begin{matrix}{U}_{n}^{0} = {a}_{n} ⊕ {b}_{n } \\ {R}_{n}^{0} = {a}_{n - 1} \cdot {b}_{n - 1}\end{matrix}$$

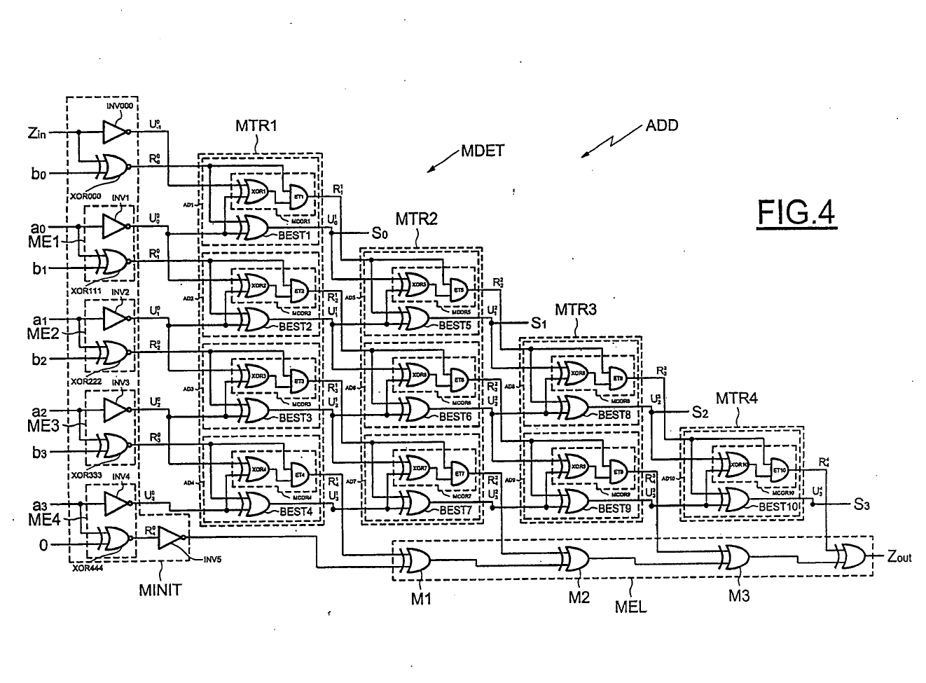

Reference is now made to FIG. 4, where the initialisation means MINIT are designed according to another embodiment.

Due to the implementation of these new initialisation means, this embodiment has the advantage of being compatible with the logic of reversibility.

In this embodiment, the elementary initialisation means MEi each comprise an inverter gate INViii, i ranging from 1 to 4, capable of receiving the bit aᵢ₋₁ and of delivering the initial value of the estimated bit of the sum Uᵢ₋₁⁰.

The means MEi also comprise a logic gate of the “EXCLUSIVE OR” type with an inverter output, referenced XORiii and receiving as input the bit aᵢ₋₁ and the bit bᵢ. Each logic gate XORiii delivers as output the correction signal Rᵢ⁰.

The logic gate XOR444 receives as input, instead of the bit of the second input number B, the binary value “0”.

Furthermore, the cell XOR444 is connected to the production means MEL via another inverter gate INV5.

In this new embodiment of the means MINIT, the correction signal R₀⁰ is delivered by a logic gate of the “EXCLUSIVE OR” type with an inverter output, referenced XOR000, receiving as input the carry value Zᵢₙ and the input bit b₀.

The initialisation variable U₋₁⁰ is delivered by an inverter gate INV000 receiving as input the carry value Zᵢₙ.

Consequently, the terms Uₙ⁰ and Rₙ⁰, ranging from 0 to 4, are given by the following equation:

$$\{ \begin{matrix}{U}_{n}^{0} = \overline{{a}_{n}} \\ {R}_{n}^{0} = \overline{{a}_{n - 1} ⊕ {b}_{n}}\end{matrix}$$

where U₄⁰=1.

In this case, the expression of the output carry value Zₒᵤₜ is equal to:

Zₒᵤₜ=U₄⁰⊕R₄⁰⊕R₄¹⊕R₄²⊕R₄³⊕R₄⁴=1⊕R₄⁰⊕R₄¹⊕R₄²⊕R₄³⊕R₄⁴|

In the following table, the addition of two binary numbers A=1000 and B=1111 is carried out for example, with an input carry value Zᵢₙ=1.

| Index n | 3 | 2 | 1 | 0 | Zᵢₙ |
|---|---|---|---|---|---|
| A | 1 | 0 | 0 | 0 | 1 |
| B | 1 | 1 | 1 | 1 | |
| Uₙ⁰ = a̅ₙ̅ | 0 | 1 | 1 | 1 | 0 |
| Rₙ⁰ = b̅ₙ̅ ⊕̅ a̅ₙ̅₋̅₁̅ | 0 | 0 | 0 | 1 | |
| Uₙ¹ = Uₙ⁰ ⊕ Rₙ⁰ | 0 | 1 | 1 | 0 | |
| Rₙ¹ = (Uₙ₋₁⁰ ⊕ Uₙ₋₂⁰) · Rₙ₋₁⁰ | 0 | 0 | 1 | | |
| Uₙ² = Uₙ¹ ⊕ Rₙ¹ | 0 | 1 | 0 | | |
| Rₙ² = (Uₙ₋₁¹ ⊕ Uₙ₋₂¹) · Rₙ₋₁¹ | 0 | 1 | | | |
| Uₙ³ = Uₙ² ⊕ Rₙ² | 0 | 0 | | | |
| Rₙ³ = (Uₙ₋₁² ⊕ Uₙ₋₂²) · Rₙ₋₁² | 1 | | | | |
| Uₙ⁴ = Uₙ³ ⊕ Rₙ³ | 1 | | | | |
| Rₙ⁴ = (Uₙ₋₁³ ⊕ Uₙ₋₂³) · Rₙ₋₁³ | | | | | |
| S | 1 | 0 | 0 | 0 | |

It is considered in this example that the determination means MDET comprise the initialisation means shown in FIG. 4.

During a first step, the initialisation values Uₙ⁰ and Rₙ⁰ are calculated according to the expressions defined above. A first estimate of the sum S is then made by calculating the bits Uₙ¹. The correction signals Rₙ¹ are then determined. These steps are successively repeated for the other bits of the sum S. Finally, the sum S is equal to 1000. The situation is then that of a standard carry value propagation.

In another example shown in the table below, a number A equal to 0111 and a number B equal to 0000 are added, the input carry value Zᵢₙ being zero.

| Index n | 3 | 2 | 1 | 0 | Zᵢₙ |
|---|---|---|---|---|---|
| A | 0 | 1 | 1 | 1 | 0 |
| B | 0 | 0 | 0 | 0 | |
| Uₙ⁰ = a̅ₙ̅ | 1 | 0 | 0 | 0 | 1 |
| Rₙ⁰ = b̅ₙ̅ ⊕̅ a̅ₙ̅₋̅₁̅ | 0 | 0 | 0 | 1 | |
| Uₙ¹ = Uₙ⁰ ⊕ Rₙ⁰ | I | 0 | 0 | 1 | |
| Rₙ¹ = (Uₙ₋₁⁰ ⊕ Uₙ₋₂⁰) · Rₙ₋₁⁰ | 0 | 0 | 1 | | |
| Uₙ² = Uₙ¹ ⊕ Rₙ¹ | 1 | 0 | 1 | 1 | |
| Rₙ² = (Uₙ₋₁¹ ⊕ Uₙ₋₂¹) · Rₙ₋₁¹ | 0 | 1 | | | |
| Uₙ³ = Uₙ² ⊕ Rₙ² | 1 | 1 | 1 | 1 | |
| Rₙ³ = (Uₙ₋₁² ⊕ Uₙ₋₂²) · Rₙ₋₁² | 1 | | | | |
| Uₙ⁴ = Uₙ³ ⊕ Rₙ³ | 0 | 1 | 1 | 1 | |
| Rₙ⁴ = (Uₙ₋₁³ ⊕ Uₙ₋₂³) · Rₙ₋₁³ | 0 | | | | |
| S | 0 | 1 | 1 | 1 | |

By repeating the same operations as those described above, the sum S is equal to 0111.

The situation is that of a correction propagation, since the initial estimated value 1000 has become after correction the value 0111.

Of course, it is possible to combine several adders as described above, within one and the same system, in order to add more than two binary numbers.

For example, in order to add 3 binary numbers, A, B and C, the system in question may comprise a first adder and a second adder. The first adder receives as input the first and second binary numbers, respectively A and B, and produces as output a sum A+B.

The second adder receives as input the intermediate sum A+B and also the third binary number C, and produces a sum S corresponding to the sum of the three binary input numbers A, B and C.

For each additional binary number to be added, the system comprises one additional adder.

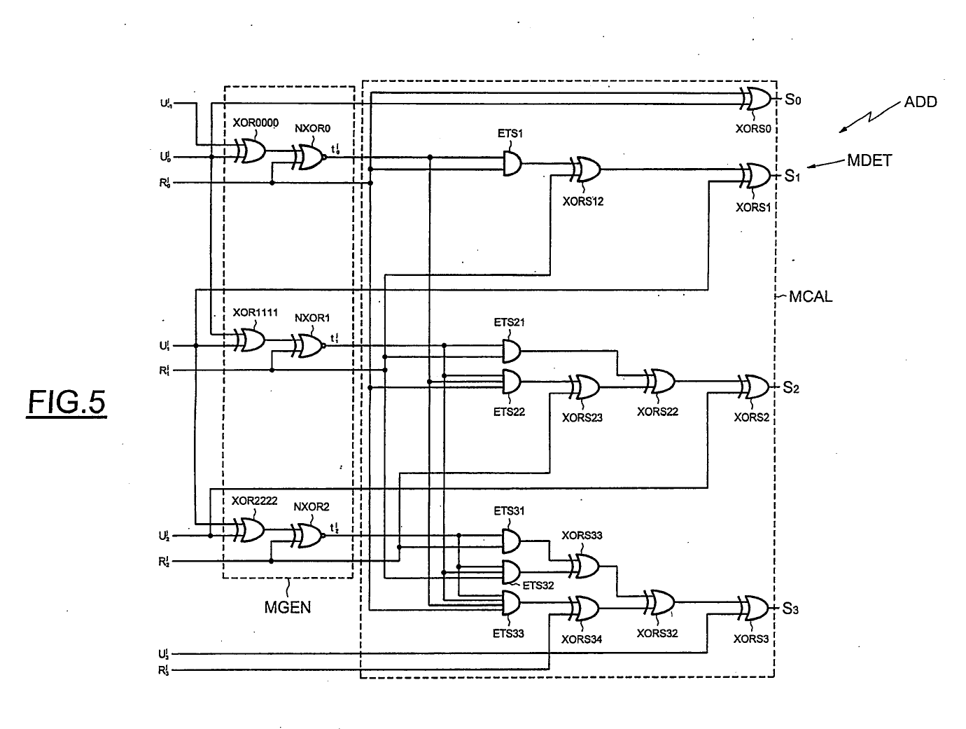

Reference is now made to FIG. 5.

The embodiment of the determination means MDET shown in FIG. 5 comprises generation means capable of receiving the signals U₋₁^{j}, U₀^{j}, R₀^{j}, . . . , U₃^{j}, R₃^{j}.

These signals are determined by an adder according to an aspect of the invention, for example according to one of the embodiments shown in FIG. 3 or 4.

The signals U₋₁^{j}, U₀^{j}, R₀^{j}, . . . , U₂^{j}, R₂^{j} are delivered as input to generation means MGEN which produce propagation signals t₀^{j}, t₁^{j} and t₂^{j}, which are calculated from the expression:

tₙ₋₁^{j}=(Uₙ₋₁^{j}⊕Rₙ₋₁^{j}⊕Uₙ₋₂^{j}⊕1)=( U̅ₙ̅₋̅₁̅^̅{̅j̅}̅⊕̅R̅ₙ̅₋̅₁̅^̅{̅j̅}̅⊕̅U̅ₙ̅₋̅₂̅^̅{̅j̅}̅), |

with n ranging from 1 to 3 and j being any integer, here between 0 and 3.

These generation means make it possible to accelerate the calculation of the bits S0, S1, S2 and S3, which are then obtained by the following relationships:

$$\{ \begin{matrix}{s}_{0} = {U}_{0}^{j + 1} = {U}_{0}^{j} ⊕ {R}_{0}^{j} \\ {s}_{1} = {U}_{1}^{j + 2} = {U}_{1}^{j} ⊕ {R}_{1}^{j} ⊕ {t}_{0}^{j} \cdot {R}_{0}^{j} \\ {s}_{2} = {U}_{2}^{j + 3} = {U}_{2}^{j} ⊕ {R}_{2}^{j} ⊕ {t}_{1}^{j} \cdot {R}_{1}^{j} ⊕ {t}_{1}^{j} \cdot {t}_{0}^{j} \cdot {R}_{0}^{j} \\ {s}_{3} = {U}_{3}^{j + 4} = {U}_{3}^{J} ⊕ {R}_{3}^{j} ⊕ {t}_{2}^{j} \cdot {R}_{2}^{j} ⊕ {t}_{2}^{j} \cdot {t}_{1}^{j} \cdot {R}_{1}^{J} ⊕ {t}_{2}^{j} \cdot {t}_{1}^{j} \cdot {t}_{0}^{j} \cdot {R}_{0}^{j}\end{matrix}$$

This embodiment of the means MDET is particularly suitable in the context of using an adder to carry out a division.

In order to produce a propagation signal tᵢ^{j}, i ranging from 0 to 2, the generation means MGEN comprise a logic gate of the “EXCLUSIVE OR” type, referenced XORiiii, capable of receiving as input the signal Uᵢ^{j} and the signal Uᵢ₋₁^{j}.

The logic gate XORiiii is connected to a logic gate of the “EXCLUSIVE OR” type with an inverter output, referenced NXORi. The logic gate NXORi receives as input the output signal delivered by the logic gate XORiiii and the signal Rᵢ^{j}.

The gate NXORi delivers as output the propagation signal tᵢ^{j}.

The output of the generation means MGEN is coupled to calculation means, so as to calculate the bits of the sum S, i.e. S0, . . . , S3.

The bit S0 is then produced using a logic gate of the “EXCLUSIVE OR” type, referenced XORS0. The latter receives as input the signal R₀^{j} and the estimated bit of the sum U₀^{j}.

The bit S1 of the sum S is delivered by a logic gate of the “EXCLUSIVE OR” type, referenced XORS1. The latter receives as input the estimated bit of the sum U₁^{j} and the output signal from another logic gate of the “EXCLUSIVE OR” type, referenced XORS12.

The gate XORS12 receives as input the correction signal R₁^{j} and the output signal from a logic gate of the “AND” type, referenced ETS1. The latter receives as input the propagation signal t₀^{j} and the correction signal R₀^{j}.

The bit S2 of the sum S is delivered by a logic gate of the “EXCLUSIVE OR” type, referenced XORS2, which receives as input the estimated bit U₂^{j} and the output signal from another logic gate of the “EXCLUSIVE OR” type, referenced XORS22.

The logic gate XORS22 receives as input the output signal from a logic gate of the “EXCLUSIVE OR” type, referenced XORS23, and the output signal from a logic gate of the “AND” type, referenced ETS21. The latter receives as input the propagation signal t₁^{j} and the correction signal R₁^{j}.

The logic gate XORS23 receives as input the correction signal R₂^{j} and the output signal from another logic gate of the “AND” type, referenced ETS22, which receives as input propagation signals t₁^{j} and t₀ⱼ and the correction signal R₀^{j}.

The bit S3 of the sum S is delivered by a logic gate XORS3 of the “EXCLUSIVE OR” type.

The latter receives as input the estimated bit U₃^{j} and the output signal from another logic gate of the “EXCLUSIVE OR” type, referenced XORS32.

The latter receives as input the output signals from two other logic gates of the “EXCLUSIVE OR” type, respectively XORS34 and XORS33.

The logic gate XORS34 receives as input the correction signal R₃^{j} and the output signal from a logic gate of the “AND” type, referenced ETS33, which receives as input the propagation signals t₀^{j}, t₁^{j} and t₂^{j} and the correction signal R₀^{j}.

The logic gate referenced XORS33 receives as input the output signals from two other gates of the “AND” type, respectively ETS31 and ETS32.

The gate ETS31 receives as input the propagation signal t₂^{j} and the correction signal R₂^{j}.

The logic gate ETS32 receives as input the propagation signals t₁^{j} and t₂^{j} and the correction signal R₁^{j}.

The propagation signals produced by this type of determination means can be used in adders of the CLA (“Carry-Look-Ahead”) type, to add 2n bits. For this, several means MDET capable of generating propagation signals, in this case called group propagation signals, and group generation signals are coupled in parallel in the case of adding 2n bits as described below.

All of the means MDET are combined to form a module known as the group propagation module which is well known to the person skilled in the art (see for example the reference work “Advanced Computer Arithmetic Design” M. J. Flynn, S. F. Obermann, 2001, Editions John Wiley and sons, ISBN 0-471-41209-0, pages 4 and 5). From the group generation signals and the group propagation signals generated by the means MDET which add the bits i, i+1, i+2 and i+3 (for example), the group propagation module produces a carry value (or input generation term) for the means MDET which add the bits i+4, i+5, i+6 and i+7.

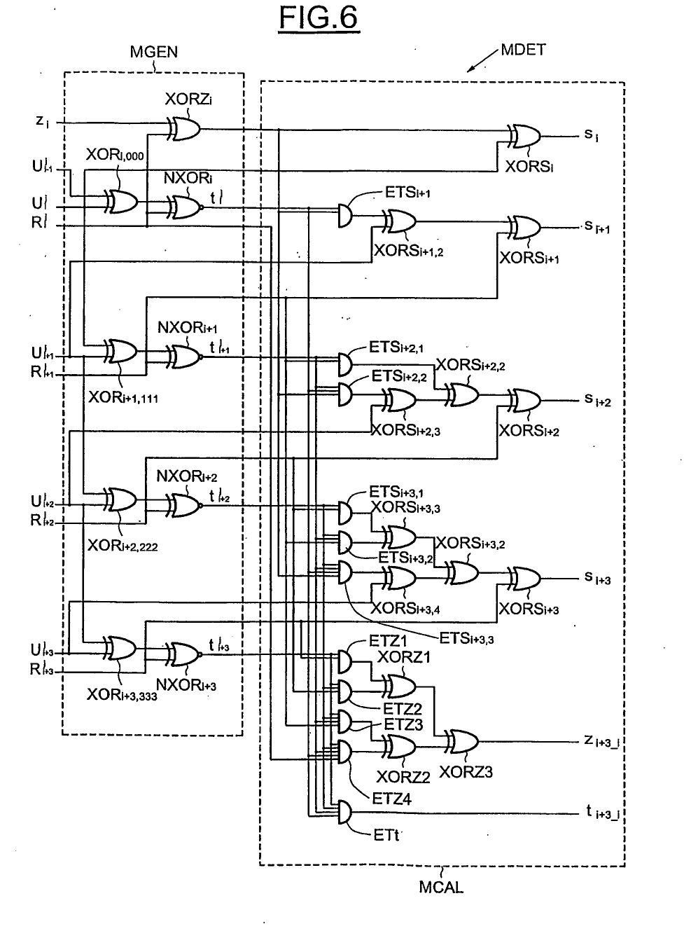

FIG. 6 shows means MDET which are used in the context of a coupling with other means MDET so as to form an adder of the CLA type capable of adding 2n bits.

The means MDET in FIG. 6 are used to produce the terms Si, . . . , Si+3 of the sum S and the so-called group generation and group propagation signals, respectively Zᵢ₊₃_{_{—}}ᵢ and tᵢ₊₃_{_{—}}ᵢ for the module producing the input generation term for the following means MDET, as explained below.

The means MGEN in FIG. 6 additionally comprise, compared to the means shown in FIG. 5, a gate XORZi which receives as input the carry value (input generation term) Zi generated by the means MDET connected upstream and the signal Rⁱⱼ. The output of the gate XORZi is connected to the input of the gates XORSi, ETSi+1, ETSi+1, 2, ETSi+3, 3.

Furthermore, the means MGEN comprise two logic gates XORi+3,333 and NXORi+3, respectively of the “EXCLUSIVE OR” and “EXCLUSIVE OR with an inverter output” type.

The gate XORi+3,333 receives as input the signal U^{j}ᵢ₊₃ and U^{j}ᵢ₊₂. Its output is connected to the input of the gate NXORi+3.

The gate NXORi+3 also receives as input the signal R^{j}ᵢ₊₃ and delivers as output another propagation signal t^{j}ᵢ₊₃.

Moreover, the bit Zᵢ₊₃_{_{—}}ᵢ is delivered by a logic gate XORZ3 of the “EXCLUSIVE OR” type.

The latter receives as input the output signals from two other logic gates of the “EXCLUSIVE OR” type, respectively referenced XORZ1 and XORZ2.

The logic gate XORZ1 receives as input the output signals from two logic gates of the “AND” type, respectively referenced ETZ1 and ETZ2.

The logic gate XORZ2 receives as input the output signals from two logic gates of the “AND” type, respectively referenced ETZ3 and ETZ4.

The logic gate ETZ1 receives as input the propagation signal tᵢ₊₃^{j} and the correction signal Rᵢ₊₃^{j}.

The logic gate ETZ2 receives as input the propagation signals tᵢ₊₃^{j} and tᵢ₊₂^{j} and the correction signal Rᵢ₊₂^{j}.

The logic gate ETZ3 receives as input the propagation signals tᵢ₊₃^{j} and tᵢ₊₂^{j}, tᵢ₊₁^{j} and the correction signal Rᵢ₊₁^{j}.

The logic gate ETZ4 receives as input the propagation signals tᵢ₊₃^{j} and tᵢ₊₂^{j}, tᵢ₊₁^{j}, t₁^{j} and the correction signal Rᵢ^{j}.

Finally, the means MCAL also comprise another logic gate of the “AND” type, referenced ETt, receiving as input the propagation signals tᵢ₊₃^{j} and tᵢ₊₂^{j}, tᵢ₊₁^{j}, t₁^{j} and delivering as output the signal tᵢ₊₃_{_{—}}ᵢ.

The terms of the sum S and the signals Zᵢ₊₃_{_{—}}ᵢ and tᵢ₊₃_{_{—}}ᵢ are thus generated according to the following equations:

$$\{ \begin{matrix} {s}_{i} = {U}_{i}^{j} ⊕ ( {R}_{i}^{j} ⊕ {z}_{i} ) \\ {s}_{i + 1} = {U}_{i + 1}^{j} ⊕ {R}_{i + 1}^{j} ⊕ {t}_{i}^{j} \cdot ( {R}_{i}^{j} ⊕ {z}_{i} ) \\ {s}_{i + 2} = {U}_{i + 2}^{j} ⊕ {R}_{i + 2}^{j} ⊕ {t}_{i + 1}^{j} \cdot {R}_{i + 1}^{j} ⊕ {t}_{i + 1}^{j} \cdot {t}_{i}^{j} \cdot ( {R}_{i}^{j} ⊕ {z}_{i} ) \\ \begin{matrix}{s}_{i + 3} = {U}_{i + 3}^{j} ⊕ {R}_{i + 3}^{j} ⊕ {t}_{i + 2}^{j} \cdot {R}_{i + 2}^{j} ⊕ {t}_{i + 2}^{j} \cdot {t}_{i + 1}^{j} \cdot \\ {R}_{i + 1}^{j} ⊕ {t}_{i + 2}^{j} \cdot {t}_{i + 1}^{j} \cdot {t}_{i}^{j} \cdot ( {R}_{i}^{j} ⊕ {z}_{i} ) \end{matrix} \\ {z}_{i + 3 \_i} = {t}_{i + 3}^{j} \cdot {R}_{i + 3}^{j} ⊕ {t}_{i + 3}^{j} \cdot {t}_{i + 2}^{j} \cdot {R}_{i + 2}^{j} ⊕ {t}_{i + 3}^{j} \cdot {t}_{i + 2}^{j} \cdot {t}_{i + 1}^{j} \cdot {R}_{i + 1}^{j} ⊕ {t}_{i + 3}^{j} \cdot {t}_{i + 2}^{j} \cdot {t}_{i + 1}^{j} \cdot {t}_{i}^{j} \cdot {R}_{i}^{j} \\ {t}_{i + 3 \_ i} = {t}_{i + 3}^{j} \cdot {t}_{i + 2}^{j} \cdot {t}_{i + 1}^{j} \cdot {t}_{i}^{j} \end{matrix}$$

where tᵢ^{j}=( U̅ᵢ̅^̅{̅j̅}̅⊕̅R̅ᵢ̅^̅{̅j̅}̅⊕̅U̅ᵢ̅₋̅₁̅^̅{̅j̅}̅) and Zi is the input generation term.

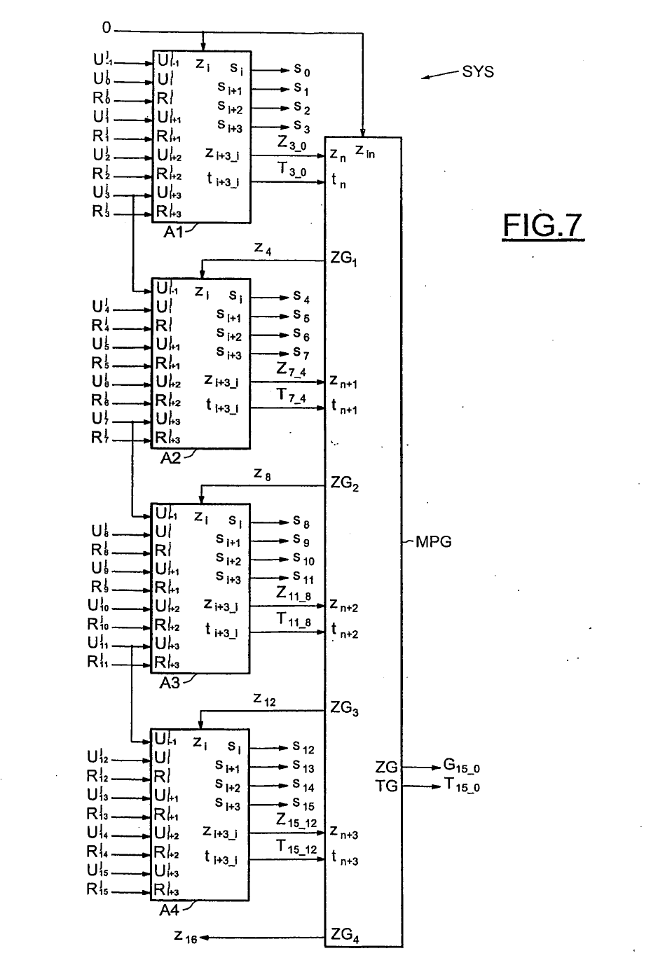

Reference is now made to FIG. 7, which shows an adder on various levels and more specifically a 16-bit adder with group carry value propagation.

This type of adder, designed in the conventional manner, is well known to the person skilled in the art.

The 16-bit adder SYS comprises four blocks A₁, A₂, A₃ and A₄ corresponding to the means MDET as described in FIG. 6.

The first block A₁ receives as input the signals U^{j}₋₁, U^{j}₀, . . . , U^{j}₃, R^{j}₀ . . . , R^{j}₃ and the input carry value Zᵢ (0 in this case), and delivers as output the first four bits of the resulting sum S₀, . . . , S₃, the group generation signal Z₃_{_{—}}₀ as defined in FIG. 6 and also the group propagation signal T₃_{_{—}}₀ (the signals U^{j}₋₁, U^{j}₀, . . . , U^{j}₃, R^{j}₀, . . . , R^{j}₃ have been produced by initialisation means as described above, not shown here for the purpose of simplification).

These signals are delivered to a group propagation module, referenced MPG, which receives as input the resulting carry value Z₃_{_{—}}₀ from the first block A₁, the group propagation signal t₃_{_{—}}₀ and the input carry value Zᵢₙ.

The group propagation module MPG produces the input generation term Z₄ for the block A2.

Similarly, the blocks A₂, A₃ and A₄ respectively receive the input signals U^{j}₄, . . . , U^{j}₇, R^{j}₄, . . . , R^{j}₇ and U^{j}₈, . . . , U^{j}₁₁, R^{j}₈, . . . , R^{j}₁₁ and U^{j}₁₂, . . . , U^{j}₁₅, R^{j}₁₂ . . . , R^{j}₁₅ and also the input generation terms Z₄, Z₈ and Z₁₂ produced by the propagation module MPG.

The block A₂ delivers as output the bits S₄, . . . , S₇ of the sum S, the block A3 delivers the output bits S₈, . . . , S₁₁ and the block A₄ delivers the bits of the sum S₁₂, . . . , S₁₅.

The term S4 is established using the following relationship:

s₄U₄^{j}⊕R₄^{j}⊕Z₃_{_{—}}₀,

where:

Z₃_{_{—}}₈=t₃^{j}·R₃^{j}⊕t₃^{j}·t₂^{j}·R₃^{j}⊕t₃^{j}·t₃^{j}·t₂^{j}·t₁^{j}·R₁^{j}⊕t₃^{j}·t₂^{j}·t₁^{j}·t₀^{j}·R₀^{j}.

Similarly:

S₈=U₈^{j}⊕R₈^{j}⊕Z₇_{_{—}}₀, |

where:

Z₃_{_{—}}₈=t₃^{j}·R₃^{j}⊕t₃^{j}·t₂^{j}·R₃^{j}⊕t₃^{j}·t₃^{j}·t₂^{j}·t₁^{j}·R₁^{j}⊕t₃^{j}·t₂^{j}·t₁^{j}·t₀^{j}·R₀^{j}⊕t₃^{j}·₂^{j}·₁^{j}·₀^{j}·Z₃_{₁₃} ₈.

S16 is obtained in the same way.

The module MPG generates a resulting carry value Z₁₆ and also a group generation signal G₁₅_{_{—}}₀ and a group propagation signal T₁₅_{_{—}}₀.

The signals G₁₅_{_{—}}₀ and T₁₅_{_{—}}₀ correspond respectively to the group generation and propagation signals of all the blocks A1, . . . , A4.

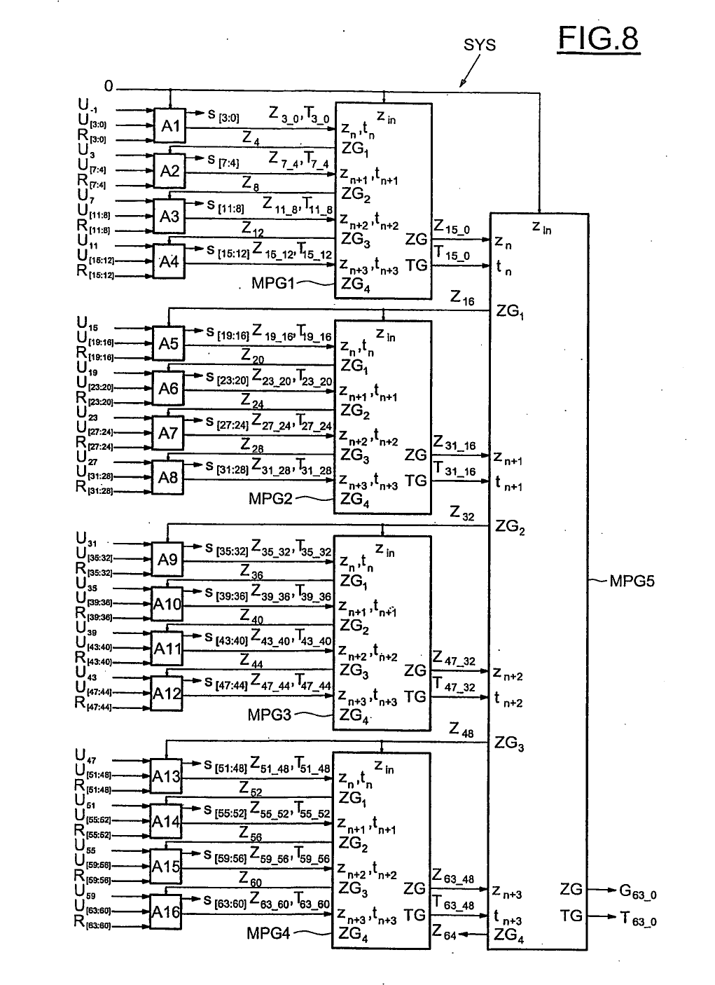

FIG. 8 also shows an adder with group carry value propagation, receiving 64 bits as input. This type of adder, which is well known to the person skilled in the art, can be used with means MDET as described in FIG. 5 and also two group propagation module levels.

The system SYS comprises a first level consisting of four group propagation modules MPG1, MPG2, MPG3 and MPG4. Each group propagation module is connected to four sub-blocks, respectively A₁, . . . , A₄ and A₅, . . . , A₈ and A₉, . . . , A₁₂ and A₁₃, . . . , A₁₆, corresponding to the means MDET shown in FIG. 5.

The second group propagation module level comprises a module MPG5 which receives as input the output signals delivered by each group propagation module of the first level.

The adder as described above can be used instead of a conventional 64-bit adder, with group carry value propagation in all configurations.

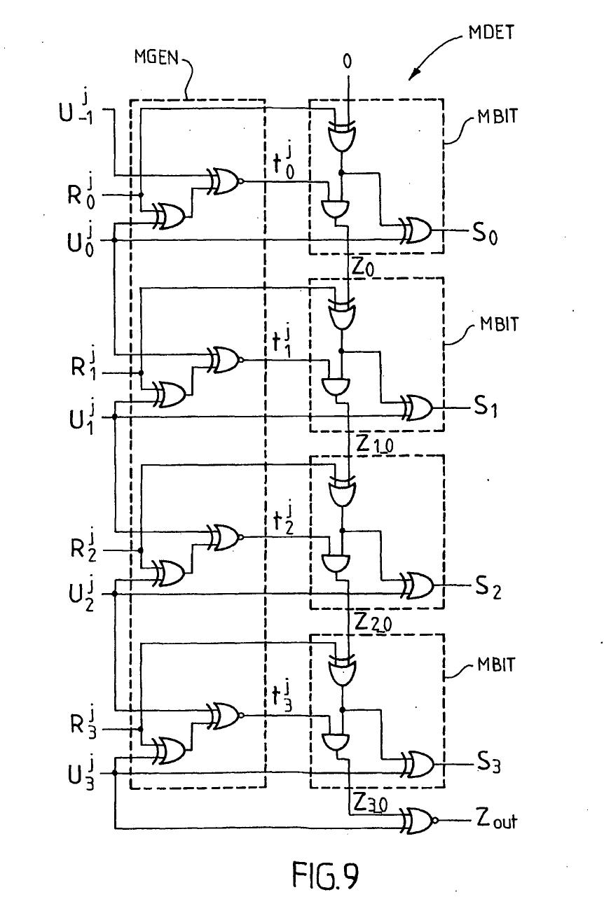

Another embodiment of the determination means MDET will now be described with reference to FIG. 9.

The means MDET comprise generation means MGEN capable of receiving the signals U₁^{j}, U₀^{j}, R₀^{j}, . . . , U₃^{j}, R₃^{j}.

The latter are determined by an adder according to an aspect of the invention, for example according to one of the embodiments shown in FIG. 3 or 4.

The signals U₁^{j}, U₀^{j}, . . . , U₂^{j}, R₂^{j} are delivered as input to the generation means MGEN, which produce propagation signals t₀^{j}, t₁^{j} and t₂^{j} which are calculated using the expression:

tₙ₋₁^{j}=(Uₙ₋₁^{j}⊕Rₙ₋₁^{j}⊕Uₙ₋₂^{j}⊕1)=( U̅ₙ̅₋̅₁̅^̅{̅j̅}̅⊕̅R̅ₙ̅₋̅₁̅^̅{̅j̅}̅⊕̅U̅ₙ̅₋̅₂̅^̅{̅j̅}̅),

with n ranging from 1 to 3 and j being any integer, here between 0 and 3.

The means MDET furthermore comprise means MBIT. These means MBIT carry out calculations at the level of each bit and are fed the output signals from the generation means MGEN, the latter making it possible to accelerate the calculation of the output signals S0, S1, S2 and S3 and of the output carry value Zₒᵤₜ from said means MBIT.

The output signals from the means MBIT are obtained by the following relationships:

$$\{ \begin{matrix}{S}_{0} = {U}_{0}^{j + 1} = {U}_{0}^{j} ⊕ {R}_{0}^{j} \\ {S}_{1} = {U}_{1}^{j + 2} = {U}_{1}^{j} ⊕ {R}_{1}^{j} ⊕ {z}_{0} \\ {S}_{2} = {U}_{2}^{j + 3} {U}_{2}^{j} ⊕ {R}_{2}^{j} ⊕ {z}_{1 \_ 0} \\ {S}_{3} = {U}_{3}^{j + 4} = {U}_{3}^{j} ⊕ {R}_{3}^{j} ⊕ {z}_{2 \_ 0} \\ {Z}_{out} = {U}_{3}^{j} ⊕ 1 ⊕ {z}_{3 \_ 0} \end{matrix} \\ where \text{:} \{ \begin{matrix}{Z}_{0} = {t}_{0}^{j} \cdot {R}_{0}^{j} \\ {Z}_{1 \_ 0} = {t}_{1}^{j} \cdot {R}_{1}^{j} ⊕ {t}_{1}^{j} \cdot {t}_{0}^{j} \cdot {R}_{0}^{j} \\ {Z}_{2 \_ 0} = {t}_{2}^{j} \cdot {t}_{1}^{j} \cdot {R}_{1}^{j} ⊕ {t}_{3}^{j} \cdot {t}_{1}^{j} \cdot {t}_{0}^{j} \cdot {R}_{0}^{j} \\ {Z}_{3 \_ 0} = {t}_{3}^{j} \cdot {R}_{3}^{j} ⊕ {t}_{3}^{j} \cdot {t}_{2}^{j} \cdot {R}_{2}^{j} ⊕ {t}_{3}^{j} \cdot {t}_{2}^{j} \cdot {t}_{1}^{j} \cdot {R}_{1}^{j} ⊕ {t}_{3}^{j} \cdot {t}_{2}^{j} \cdot {t}_{1}^{j} \cdot {t}_{0}^{j} \cdot {R}_{0}^{j}\end{matrix}$$

The signals Z₀, Z₁_{_{—}}₀, Z₂_{_{—}}₀ and Z₃_{_{—}}₀ are for their part carry value signals which are transmitted between calculation means MBIT.

This simple and iterative embodiment of the means MDET is particularly compact and therefore suitable for use in an integrated circuit.

In FIG. 9, each means MBIT of rank (n+1) comprises a first “EXCLUSIVE OR” logic gate capable of receiving the carry value signal Zₙ₋₁_{_{—}}₀ generated by the means MBIT of rank (n) and the correction signal Rₙ^{j}. The delivered signal is fed to an “AND” logic gate which has as second input the signal tₙ^{j} from the means MGEN, the output of this “AND” logic gate constituting the carry value signal Zₙ_{_{—}}₀ propagated towards the means MBIT of rank (n+2). The means MBIT also comprises a second logic gate of the “EXCLUSIVE OR” type, receiving as first input the signal generated by said first “EXCLUSIVE OR” gate and as second input the signal Uₙ^{j}, and delivering as output the signal Sₙ. A carry value signal Zₒᵤₜ is generated by an “EXCLUSIVE OR” logic gate with an inverter output which receives as input the carry value signal Z₃_{_{—}}₀ delivered by the means MBIT of rank 4 and the signal U₃^{j}.

The person skilled in the art will know how to generalise all of the embodiments described above for any number of bits of the input numbers.

Although the present disclosure has been described with reference to one or more examples, workers skilled in the art will recognize that changes may be made in form and detail without departing from the scope of the disclosure and/or the appended claims.

1. Method for adding input signals comprising first and second binary input numbers, of N bits each, wherein the bits of a sum of the input signals is determined by making a number of estimates (j) of each bit of said sum and by correcting said estimates (U^{j}) with the aid of a correction signal (R^{j}) after each estimate, each correction bit of rank (n+1)(Rₙ^{j}) being produced using a last estimate of the bit of rank (n) (Uₙ₋₁^{j-1}), a last correction bit of rank (n) (Rₙ₋₁^{j-1}), and a last estimate of the bit of rank (n−1) (Uₙ₋₂^{j-1}).

2. Method according to claim 1, in which the input signals further comprise an input carry value (Zᵢₙ).

3. Method according to claim 1, further comprising an initialisation step in which the value of the estimated bits of said sum and the value of the correction signals are initialised, and j successive processing steps, j being an integer less than or equal to N, where, during the k^{th} step, k ranging from 1 to j, the bits of the sum for which the rank i is between k and N are estimated, and the i^{th} correction signal is produced for each bit of rank i, each estimated bit of the sum of rank i being estimated from the estimated bit of the sum of rank i and from the i^{th} correction signal, respectively estimated and produced during the previous step, the i^{th} correction signal being produced from the estimated bits of the sum of rank i−1 and of rank i−2 and from the (i−1)^{th} correction signal, respectively estimated and produced during the previous step.

4. Method according to claim 1, in which an output carry value (Zₒᵤₜ) is further produced from all of the N^{th} correction signals.

5. Method according to claim 3, in which the initialisation of each estimated bit of said sum is a function of the bits of equal rank of the first and second input numbers, and the initialisation of the value of the correction signal of each estimated bit is a function of the bits of previous rank of the first and second input numbers.

6. Method according to claim 5, in which:
$$\{ \begin{matrix}{U}_{n}^{0} = {a}_{n} ⊕ {b}_{n } \\ {R}_{n}^{0} = {a}_{n - 1} \cdot {b}_{n - 1}\end{matrix}$$
where:
Uₙ⁰ is the initial value of the estimated bit of the sum of the input signals, of rank n+1, n ranging from 0 to N−1,
Rₙ⁰ is the initial value of the correction signal of the estimated bit of the sum of the input signals, of rank n+1, n ranging from 0 to N−1,
aₙ and bₙ being the bits of rank n+1, respectively of the first and second input numbers.

7. Method according to claim 3, in which the initialisation of each estimated bit of said sum is a function of the complement of the bit of equal rank of the first input number, and the initialisation of the value of the correction signals of each estimated bit is a function of the bit of previous rank of the first input number and of the bit of equal rank of the second input number.

8. Method according to claim 7, in which:
$$\{ \begin{matrix}{U}_{n}^{0} = \overline{{a}_{n}} \\ {R}_{n}^{0} = \overline{{a}_{n - 1} ⊕ {b}_{n}}\end{matrix}$$
where:
Uₙ⁰ is the initial value of the estimated bit of the sum of the input signals, of rank n+1, n ranging from 0 to N−1,
Rₙ⁰ is the initial value of the correction signal of the estimated bit of the sum of the input signals, of rank n+1, n ranging from 0 to N−1,
aₙ and bₙ being the bits of rank n+1, respectively of the first and second input numbers.

9. Method according to claim 3, in which j is equal to N, and in which the bit of rank k of said sum corresponds to the estimated bit of rank k of the sum, estimated during the k^{th} processing step.

10. Method according to claim 3, further comprising, after the j processing steps, a step of generating N−1 propagation signals (tₙ^{j}), the q^{th} propagation signal being a function of the estimated bit of said sum of rank q, of its correction signal, and of the estimated bit of rank q−1 of said sum, and in which each bit of said sum is calculated from the q^{th} propagation signals, such that q is below the rank of the bit in question.

11. Adder for adding input signals comprising first and second binary input numbers, of N bits each, wherein said adder comprises determination means (MDET) capable of determining the bits of the sum of the input signals, comprising:
estimating means comprising estimating blocks (BESTi) connected in series, each estimating block being capable of estimating each bit of said sum, and
correction means (MCORi) capable of producing a correction signal so as to correct, after each estimate, each estimated bit of said sum, each correction signal for correcting an estimated bit of rank i of the sum being produced using a last estimated and corrected bit of rank i−1 of the sum, the correction signal of said last bit of rank i−1, and a last estimated and corrected bit of rank i−2 of the sum.

12. Adder according to claim 11, in which the input signals further comprise an input carry value (Zᵢₙ).

13. Adder according to claim 11, further comprising initialisation means (MINIT) coupled upstream of the determination means and capable of initialising the value of the estimated bits of said sum and the value of the correction signals, the determination means comprising j processing means coupled in series, j being an integer less than or equal to N, where the k^{th} processing means, k ranging from 1 to j, comprise:
said estimating blocks (BESTi) for estimating the bits of the sum for which the rank i is between k and N, being estimated from the estimated bit of the sum of rank i and from the i^{th} correction signal, respectively estimated and produced by the processing means connected upstream, and
the correction means (MCORi) capable of producing, for each bit of rank i, the i^{th} correction signal from the estimated bits of the sum of rank i−1 and of rank i−2 and from the (i−1)^{th} correction signal, respectively estimated and produced by the processing means connected upstream.

14. Adder according to claim 13, in which, for the k^{th} processing means, each estimating block for estimating a bit of the sum of rank i comprises a logic gate of the “EXCLUSIVE OR” type capable of receiving as input the estimated bit of the sum of rank i and the i^{th} correction signal, respectively estimated and produced by the (k−1)^{th} processing means, and in which the correction means for correcting an estimated bit of the sum of rank i+1 comprise another logic gate of the “EXCLUSIVE OR” type capable of receiving as input the estimated and corrected bit of the sum of rank i−1 and the bit of rank (i−2) of the sum estimated and produced by the (k−1)^{th} processing means, and a logic gate of the “AND” type coupled to the output of the other logic gate of the “EXCLUSIVE OR” type and capable of receiving as input the output signal of said other logic gate and the (i−1)^{th} correction signal estimated and produced by the (k−1)^{th} processing means.

15. Adder according to claim 13, in which the processing means further comprise production means (MEL) capable of producing an output carry value (Zₒᵤₜ) from all of the N^{th} correction signals.

16. Adder according to claim 13, in which the initialisation means (MINIT) are capable of initialising the value of each bit to be estimated of said sum as a function of the bits of equal rank of the first and second input numbers, and are capable of initialising the value of the correction signal of each bit to be estimated as a function of the bits of previous rank of the first and second input numbers.

17. Adder according to claim claim 16, in which the initialisation means (MINIT) comprise N elementary initialisation means (MEi), each being associated with a given rank, comprising a logic gate of the “EXCLUSIVE OR” type, capable of receiving the bits of the rank in question of the first and second input numbers, and capable of delivering, for the rank in question, the initial value of the bit to be estimated of the sum, and a logic gate of the “AND” type, capable of receiving the bits of the rank in question of the first and second input numbers, and capable of delivering the initial value of the correction signal of the estimated bit of the sum, of the rank following the rank in question.

18. Adder according to claim 16, in which the initialisation means (MINIT) comprise N elementary initialisation means (MEi), each being associated with a given rank, comprising an inverter logic gate, capable of receiving the bits of the rank in question of the first input number, and capable of delivering, for the rank in question, the initial value of the bit to be estimated of the sum, and a logic gate of the “EXCLUSIVE OR” type with an inverter output, capable of receiving the bit of the rank in question of the first input number and the bit of the rank following the rank in question of the second input number, and capable of delivering the initial value of the correction signal of the estimated bit of the sum, of the rank following the rank in question.

19. Adder according to claim 13, in which j is equal to N, and in which the bit of the sum of rank k corresponds to the bit of the sum of rank k estimated by the k^{th} processing means.

20. Adder according to claim 13, further comprising generation means (MGEN) coupled to the j^{th} processing means, capable of generating N−1 propagation signals, the q^{th} propagation signal being a function of the estimated bit of said sum of rank q, of its correction signal, and of the estimated bit of rank q−1 of said sum, and calculation means (MCAL) capable of calculating each bit of said sum from the q^{th} propagation signals, such that q is below the rank of the bit in question.

21. Adder according to claim 20, in which the generation means (MGEN) are capable of generating an N^{th} propagation signal as a function of the estimated bit of rank N, of its correction signal and of the estimated bit of rank N−1, and in which the calculation means further comprise a calculation block capable of calculating a group generation term from all of the propagation signals generated and from all of the correction signals, and a group propagation term from all of the propagation signals.

22. Adder according to claim 21, in which N is even, and in which the calculation block comprises:
N logic gates of the “AND” type, the q^{th} gate, q ranging from 1 to N, being capable of receiving k propagation signals, k ranging from 1 to q, and the k^{th} correction signal,
a network of logic gates of the “EXCLUSIVE OR” type, capable of adding all of the terms delivered at the output of the logic gates of the “AND” type, so as to produce said group generation term,
an additional logic gate of the “AND” type, capable of multiplying all of the propagation signals so as to produce said group propagation term.

23. Adder according to claim 13, wherein the means MDET comprise generation means MGEN capable of receiving the signals U₋₁^{j}, U₀^{j}, R₀^{J}, . . . Uₙ^{j}, Rₙ^{j} from the means MINIT so as to initiate propagation signals to t₀^{j}, t₁^{j}, . . . tₙ^{j}, and specific means MBIT for carrying out the calculations at the level of each bit based on said propagation signals t₀^{j}, t₁^{j}, t₂^{j}, . . . , the signals U₋₁^{j}, U₀^{j}, . . . , the correction signals R₀^{j}, R₁^{j}, . . . and the intermediate signals Z₀, Z₁₋₀, Z₂₋₀, . . . of carry values transmitted between calculation means MBIT at the level of each bit, so as to obtain the output signals S₀, S₁, S₂ . . . .

24. Adder according to claim 23, wherein the propagation signals to, t₀^{j}, t₁^{j}, . . . are calculated from the expression:
tₙ₋₁^{j}=(Uₙ₋₁^{j}⊕Rₙ₋₁^{j}⊕Uₙ₋₂^{j}⊕1)=( U̅ₙ̅₋̅₁̅^̅{̅j̅}̅⊕̅R̅ₙ̅₋̅₁̅^̅{̅j̅}̅⊕̅U̅ₙ̅₋̅₂̅^̅{̅j̅}̅),
with n ranging from 1 to 3, and j being any integer between 0 and 3.

25. Adder according to claim 24, wherein the output signals S₀, S₁, S₂, S₃ are obtained by the relationships:
$$\{ \begin{matrix}{S}_{0} = {U}_{0}^{j + 1} = {U}_{0}^{j} ⊕ {R}_{0}^{j} \\ {S}_{1} = {U}_{1}^{j + 2} = {U}_{1}^{j} ⊕ {R}_{1}^{j} ⊕ {z}_{0} \\ {S}_{2} = {U}_{2}^{j + 3} = {U}_{2}^{j} ⊕ {R}_{2}^{j} ⊕ {z}_{1 \_ 0} \\ {S}_{3} = {U}_{3}^{j + 4} = {U}_{3}^{j} ⊕ {R}_{3}^{j} ⊕ {z}_{2 \_ 0} \\ {Z}_{out} = {U}_{3}^{j} ⊕ 1 ⊕ {z}_{3 \_ 0} \end{matrix} \\ where \text{:} \{ \begin{matrix}{Z}_{0} = {t}_{0}^{j} \cdot {R}_{0}^{j} \\ {Z}_{1 \_ 0} = {t}_{1}^{j} \cdot {R}_{1}^{j} ⊕ {t}_{1}^{j} \cdot {t}_{0}^{j} \cdot {R}_{0}^{j} \\ {Z}_{2 \_ 0} = {t}_{2}^{j} \cdot {t}_{1}^{j} \cdot {R}_{1}^{j} ⊕ {t}_{3}^{j} \cdot {t}_{1}^{j} \cdot {t}_{0}^{j} \cdot {R}_{0}^{j} \\ {Z}_{3 \_ 0} = {t}_{3}^{j} \cdot {R}_{3}^{j} ⊕ {t}_{3}^{j} \cdot {t}_{2}^{j} \cdot {R}_{2}^{j} ⊕ {t}_{3}^{j} \cdot {t}_{2}^{j} \cdot {t}_{1}^{j} \cdot {R}_{1}^{j} ⊕ {t}_{3}^{j} \cdot {t}_{2}^{j} \cdot {t}_{1}^{j} \cdot {t}_{0}^{j} \cdot {R}_{0}^{j}\end{matrix}$$

26. Adder according to claim 23, wherein each means MBIT of rank (n+1) comprises a first “EXCLUSIVE OR” logic gate capable of receiving the carry value signal Zₙ₋₁_{_{—}}₀ generated by the means MBIT of rank (n) and the correction signal Rₙ^{j}, in that the signal delivered reaches an “AND” logic gate which has as a second input the signal tₙ^{j} from the means MGEN, the output of this “AND” logic gate constituting the carry value signal Zₙ_{_{—}}₀ propagated towards the means MBIT of rank (n+2), in that the means MBIT also comprises a second logic gate of the “EXCLUSIVE OR” type which receives as first input the signal generated by said first “EXCLUSIVE OR” gate and as second input the signal Uₙ^{j}, and delivers as output the signal Sₙ, and in that a carry value signal Zₒᵤₜ is generated by an “EXCLUSIVE OR” logic gate with an inverter output which receives as input the carry value signal Z₃_{_{—}}₀ delivered by the means MBIT of rank 4 and the signal U₃^{j}.

27. System comprising a network of adders, each adder for adding input signals comprising first and second binary input numbers, of N bits each, and wherein each adder comprises determination means (MDET) capable of determining the bits of the sum of the input signals, comprising:
estimating means comprising estimating blocks (BESTi) connected in series, each estimating block being capable of estimating each bit of said sum, and
correction means (MCORi) capable of producing a correction signal so as to correct, after each estimate, each estimated bit of said sum, each correction signal for correcting an estimated bit of rank i of the sum being produced using a last estimated and corrected bit of rank i−1 of the sum, the correction signal of said last bit of rank i−1, and a last estimated and corrected bit of rank i−2 of the sum.

28. (canceled)

29. System according to claim 27, in which N is a multiple of 4, in which the network of adders incorporates N/4 adders (Ai), coupled in parallel, each adder being capable of adding N/4 successive bits of the first and second binary input number, said system further comprising at least one group propagation module (MPGi) capable of receiving the group generation term and the group propagation term of each adder, and capable of producing from the group generation term and the group propagation term of a given adder a carry value for the adder which adds the following N/4 bits.

30. System according to claim 29, wherein the network of adders incorporates a second network of adders at the bit level, in which the carry value signal is propagated in cascade from the module of rank (n) to the module of rank (n+1) on a “Ripple Carry Adder” model.
